(19) United States
(12) Patent Application Publication
(10) Pub. No.: US 2009/0005179 A1
(43) Pub. Date: Jan. 1, 2009

(54) Gaming Headgear

(76) Inventor: Konstantinos Ioannis Petsalis, Crown Point, IN (US)

Correspondence Address: SEYFARTH SHAW LLP, 131 S. DEARBORN ST., SUITE 2400, CHICAGO, IL, 60603-5803, US

(21) Appl. No.: 11/770,225

(22) Filed: Jun. 28, 2007

(51) Int. Cl. A63F 13/02

(52) U.S. Cl. 463/47

(57) ABSTRACT

A headwear apparatus for enhancing a video gaming experience is disclosed. Tile headwear includes a microphone and headphones permitting two-way communication between a user and other players, as well as audio delivery from the video game. The headwear has an external aesthetic appearance selected as being relevant to, associable with, or, most specifically, identifiable with a particular video game.

### FIELD OF THE INVENTION

The invention relates to headgear and, in particular, to headgear for enhancing a video and computer game play.

### BACKGROUND

In the past, computer gaming was limited to play on a single console and to play by and amongst people immediately present with that console. For instance, video games at commercial establishments such as gaming arcades would allow for multiple players, such as the game Gauntlet that allowed four people to simultaneously proceed through screens and worlds in an imaginary setting, or video games designed for private home use like the Atari 2600 that allowed two players to compete head-to-head in tennis, or alternate turns in a game like Asteroids.

Gaming has since evolved as various communications evolved, most notably the internet and the world wide web. Technology developed for interconnecting a number of computers and users, such as local area networks (LANs) as well as the internet, have been utilized for connecting a number of gamers in simultaneous play.

Entire communities of like-minded gamers have developed, centered around games in general, a particular genre of game, or a specific game itself. These communities, sometimes called “clans,” compete around the clock from all corners of the world. Other times, people will congregate at a designated site for a competition or other gathering utilizing, for instance, a LAN in somewhat of a closed-circuit gaming environment where many people are connected and participating in a single game, or smaller groups or pairs of people are competing in separate games.

Along with this community-based gaming, other technologies have been developed. For instance, it is possible and common for garners to utilize on-line chatting with voice communications.

The result of much of this has been the advent of a variety of interest-based cultures in much the same manner that other passions and hobbies have created similar cultures. These cultures communicate and interact via their home gaming systems connected via the internet, or utilizing the internet to tie directly into a game hosted by a remote server or computer network.

People will also congregate at gathering sites, mentioned above, for events called LAN parties where anywhere from a few to several hundred garners will attend. These LAN parties may last for days, such as may be required to eliminate players from a game competition, and have received major corporate sponsorship and prize awards. Today, there are professional garners whose winnings place them among the nation's top ten percent of wage earners.

As with any culture, there has long been a need to express one's identity with that culture. Typically, for gamers, this has been limited to perhaps a mouse pad or a t-shirt that is representative or emblematic of the game or games around which the LAN party is centered.

It is also a fact that integral parts of the gaming experience are the ability to hear the sound effects provided by the game itself, and the ability (and sometimes necessity) to communicate with other players in the game. For instance, a plurality of gamers may be joined as a group playing on a common side. More specifically, a plurality of garners may all be in the same game-based platoon for a war-based game. In other instance, communication between opponents may be desirable in the same manner that opposing athletes may speak puffery to each other to gain a psychological edge.

With the development of gatherings of gamers, such as the LAN parties, a common and typically strictly enforced rule is a prohibition against the use of loudspeakers. This rule is easily understood when it is considered that several hundred people may be in a single convention hall, paired off for individual competitions, each competition having its own soundtrack; the result would understandably be termed cacophonous.

In contrast, it is generally permissible to use headphone speakers at LAN parties. The headphones are usually integrated with a small microphone positionable proximate the wearer's mouth. Typically, these headphones are nothing more than what one would expect to see on a football coach or an airtraffic controller. In a room of several hundred people, it is impossible to identify which people are playing which games, other than by looking at the game screens (which may not be easily viewable if a number of other spectators are around the gamers), or a t-shirt perhaps. Additionally, many people utilize headphones when playing in the privacy of their own home to afford others present the ability to avoid hearing the game being played.

Accordingly, there has been a need for an improved gaming experience for gaming cultures.

### SUMMARY

In accordance with an aspect, a method of enhancing gaming experiences for a consumer or gamer is disclosed. The method includes selecting a video game genre, providing a headgear apparatus, providing the headgear apparatus with an aesthetic appearance corresponding to the video game genre, and marketing the headgear apparatus as being associated with the video game genre.

The step of selecting a video game genre may include selecting a particular video game. The step of marketing may include identifying to the consumer the particular video game.

In another aspect, in combination with a video game genre, a headgear apparatus is disclosed including a helmet, at least a first headphone secured with the helmet, and a microphone secured with the helmet, wherein the helmet has an aesthetic appearance associable with the video game genre. The video game genre may be a specific selected video game having characters, and the aesthetic appearance may correspond to the aesthetic appearance of at least one of the characters of the selected video game.

In a further aspect, a headgear apparatus for enhancing video gaming is disclosed including a body portion, a microphone, and first and second headphone speakers, wherein the helmet has an aesthetic appearance associable with video gaming.

The body portion may be a helmet for wearing on a user's head. The speakers may be secured with the body portion, and the microphone may be secured with the speakers. The microphone may be secured to a boom for permitting adjustment of a position of the microphone. The headgear apparatus may further include a microphone cable, and a speaker cable, each cable provided with a jack for connecting the cables with a video gaming console. The headgear apparatus may further include a microphone cable, and a speaker cable, wherein the cables are substantially routed together.

### BRIEF DESCRIPTION OF THE DRAWINGS

In the Figures, FIG. 1 is a perspective view of a front of a form of gaming headwear of the present invention showing a helmet with integrated headphone speakers and a microphone;

FIG. 2 is a representational view of a video game character wearing a helmet;

FIG. 3 is a representational view of a video game character wearing a helmet with headphone speakers;

FIG. 4 is a side elevation view of the gaming headwear of FIG. 1;

FIG. 5 is a partial interior view of the gaming headwear of FIG. 1 showing securement between a headphone speaker and the helmet;

FIG. 6 is a second partial interior view of the gaming headwear of FIG. 1 showing securement between a second headphone speaker and the helmet;

FIG. 7 is a fragmentary view of a headphone slide volume control switch and cabling for connecting the volume control switch with the headphone speakers and for connecting with a video game console;

FIG. 8 is a fragmentary view of a microphone power switch and cabling for connecting the power switch with the microphone and for connecting with the video game console;

FIG. 9 is a bottom plan view of the gaming headgear of FIG. 1 showing the interior of the helmet, the headphone speakers, and the microphone;

FIG. 10 is a perspective view of a form of a pair of connectors for connecting the headphone speakers and the microphone with the video game console;

FIGS. 11A-11D are various forms of helmets which may be utilized with the headphone and microphone as forms of the present invention.

### DETAILED DESCRIPTION

Referring initially to FIG. 1, a form of gaming headgear 10 of the present invention is depicted. As shown, the gaming headgear 10 includes a head portion 12, a first headphone 14 for a user's left ear and a second headphone 16 for a user's right ear, and a microphone 18. The microphone 18 is a noise-canceling transducer, while the headphones 14, 16, have a preferred frequency response of 18-20,0000 Hz. It should be noted that, as the terms microphone and headphone or headphone speaker are used herein, these terms refer to both the electrical components thereof and also any housing and other features thereof normally associated with the device, such as foam padding, etc., and is not intended to refer, for instance, to simply a speaker cone or a transducer element.

The head portion 12 is constructed and/or decorated in a manner representative of a character or theme for a particular game. As shown, the head portion 12 is in the form of a helmet such as is recognizable as being for a World War II era soldier, having a distinctive shape and a spike 20 on a crown portion 22. The head portion 12 may further have indicia designating or suggesting a particular country's army or service branch, or a grouping therewithin, such as an Iron Cross or “SS” symbol for NAZI Germany, or a white star indicating a United States general infantryman.

As such, the gaming headgear 10 provides a single unitary device that can be worn on a gaming person's head, is equipped with headphones 14, 16, so that the gaming person can hear what is going on in a video game during play, including the sound effects or communications from the game itself as well as from other participants in the game, while bystanders are generally unable to hear the game, and a microphone 18 which allows the gaming person to communicate with the game or other game players. Moreover, it allows the gaming person to express their individuality or present their identity as being associated with a particular game, such as a World War II-themed game, such as in a novelty manner.

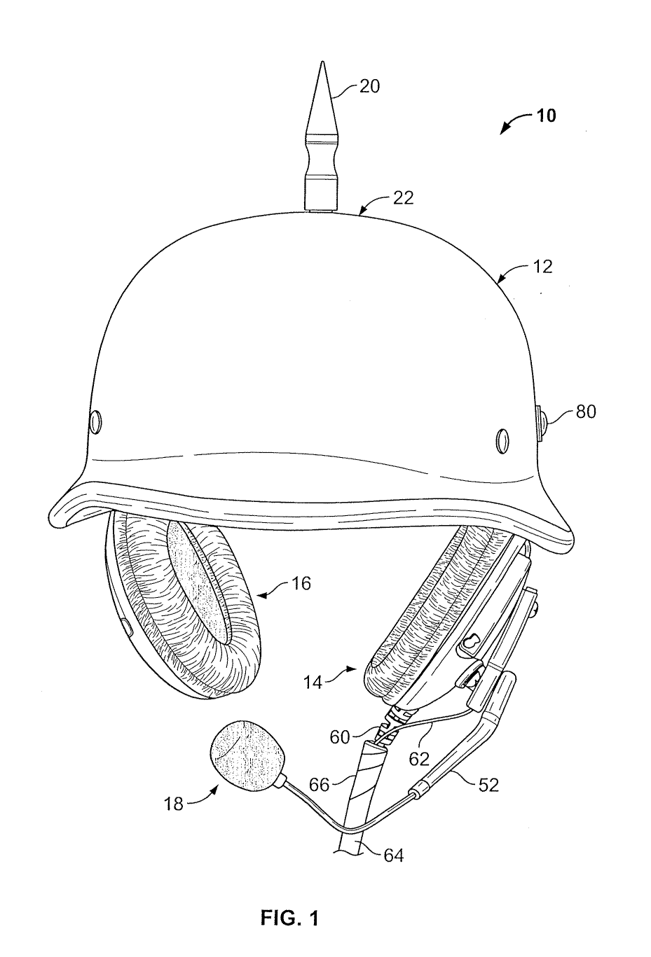

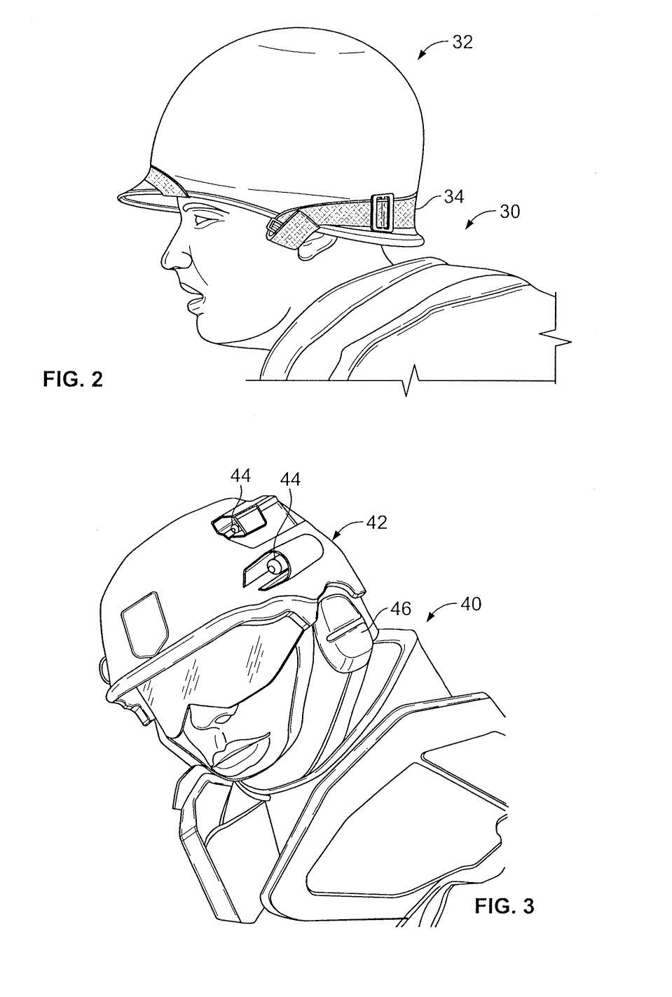

Referring to FIG. 2, a representational soldier 30 is shown having a helmet 32 with a chin strap 34 that is not being utilized. In FIG. 3, a second representational soldier 40 is shown having a helmet 42 with a variety of accoutrements 44 affixed thereto, including headphones 46. As other examples relevant to the helmet 12, in a gaming environment, a video game may utilize or present characters with the look and appearance of such soldiers 30, 40, with such helmets 32, 42.

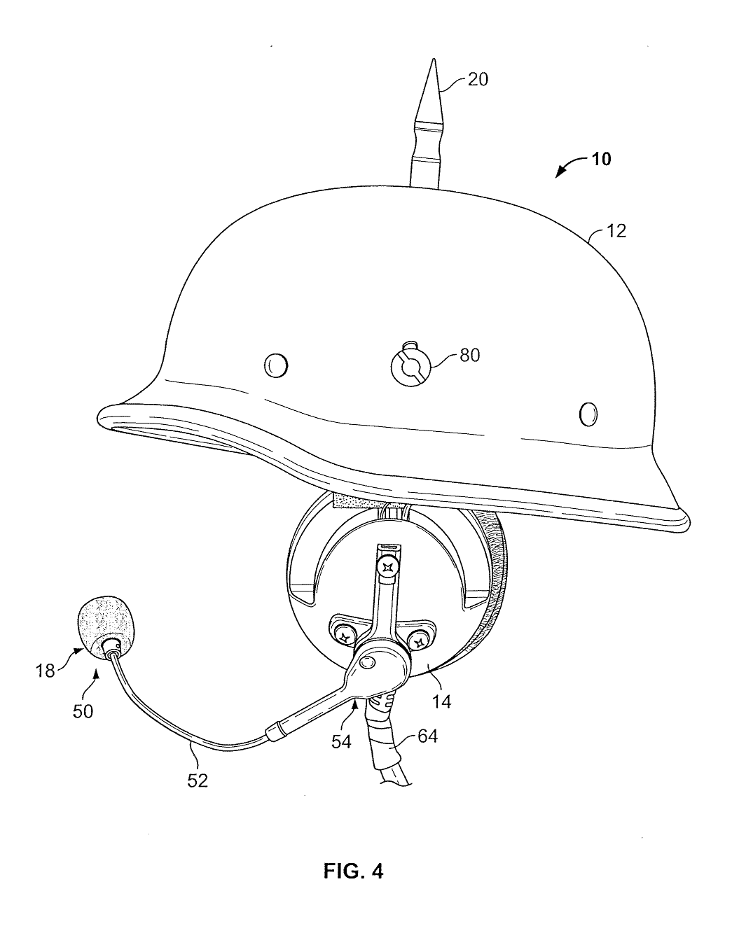

With reference to FIG. 4, the first headphone 14 is shown secured with the helmet 12, and the microphone 18 is shown as extending from the first headphone 14. The microphone 18 is positioned at a terminal end 50 of a boom 52 or other extension for supporting the microphone 18 proximate a gaming person's mouth while also permitting the gaming person to adjust the position of the microphone 18, such as would be desirable when donning the headgear 10 or when seeking access to the mouth for food and beverage, etc. For example, the boom 52 may be provided with a variety of known constructions that allow the boom 52 to be bent; alternatively and as another example, the boom 52 may be secured at a base portion 54 that allows pivoting and/or other directional adjustment for shifting the position of the boom 52. It should also be noted that the microphone 18 may be secured by a structure other than a boom 52, and either the microphone 18 or boom 52 may be secured with the helmet 12 at another location, such as directly with the helmet 12.

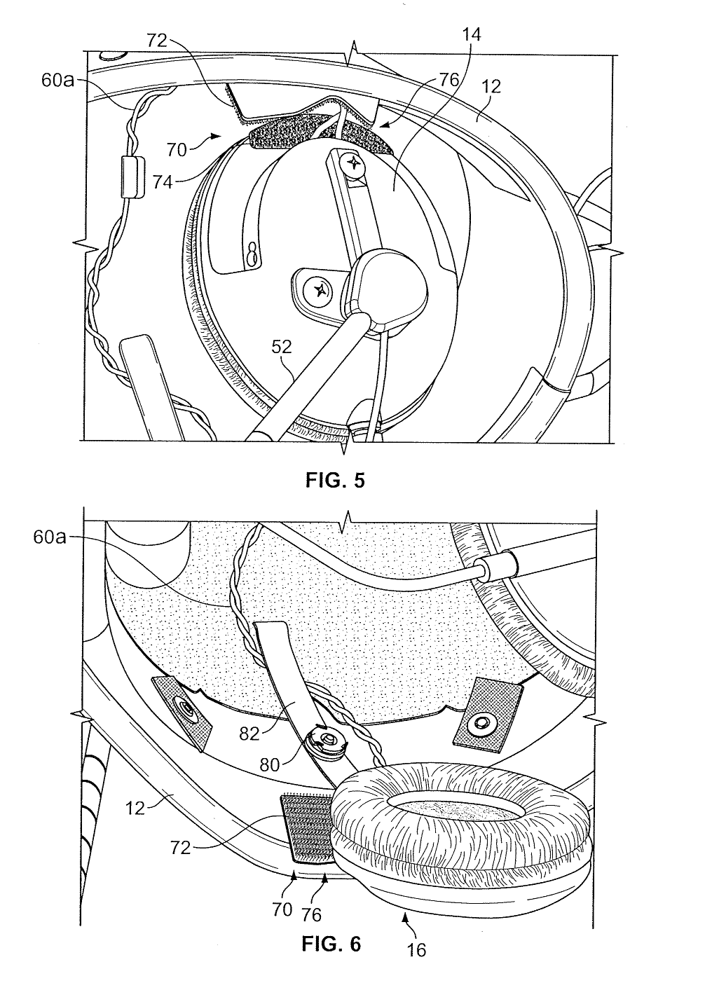

However, it is preferred to secure the microphone 18 with one of the headphones 14, 16. In greater detail, both the headphones 14, 16, and the microphone 18 are equipped with respective cables 60, 62, for connection with a video game console (not shown), thereby allowing electrical communication between the microphone 18, headphones 14, 16, and the console, and, ultimately, allowing bi-directional communication between the wearer and other gamers, as well as to allow the user to hear the sound provided by the video game console itself. As used herein, the term video game console may refer to a stand-alone system such as a PlayStation made by Sony, a computer and CPU such as a laptop or desktop computer, or a system of computers such as would be connected using a local area network (LAN). As can be seen in FIGS. 5 and 6, a double-strand subcable 60a for the second headphone 16 may be routed through the interior of the crown of the helmet 12 for being joined with a subcable of the first headphone 14, the subcables forming the cable 60.

By securing the microphone 18 with one of the headphones 14, 16, the respective cables 60, 62, are able to be managed generally as a single cable 64. In one form, the cable 64 may be manufactured as to include the cables 60, 62, while in another form the cable 64 may simply be separate cables 60, 62 having been wrapped together by, for example, a cord cover 66. The proximity of the microphone 18 with one of the headphones 14, 16, facilitates the cables 60, 62, being utilized as the single cable 64, thus minimizing the cable 64 as an impediment to game plan or the user's freedom in generally. Preferably, the cable 64 is approximately 8 feet long and includes separate 3.5 mm (⅛ inch) stereo headphone/microphone jacks 69 (see FIG. 10), each jack 69 for either the microphone 18 or for the headphones 14, 16 together. Preferably, the jacks 69 are gold-plated. Many computers are not equipped with single jack plugs that are able to receive a single jack that combines both input (microphone) and output (speaker) channels; accordingly, it is preferred to have separate jacks 69, though a single jack may alternatively be provided, or an adapter may be utilized to combine the signal channels of the two jacks 69.

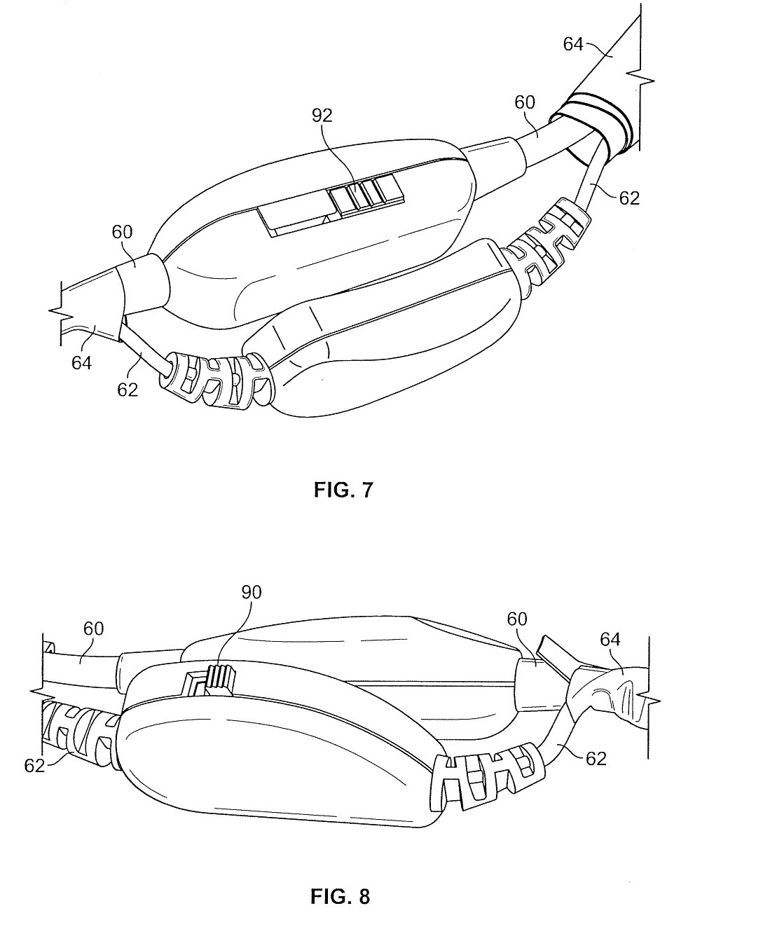

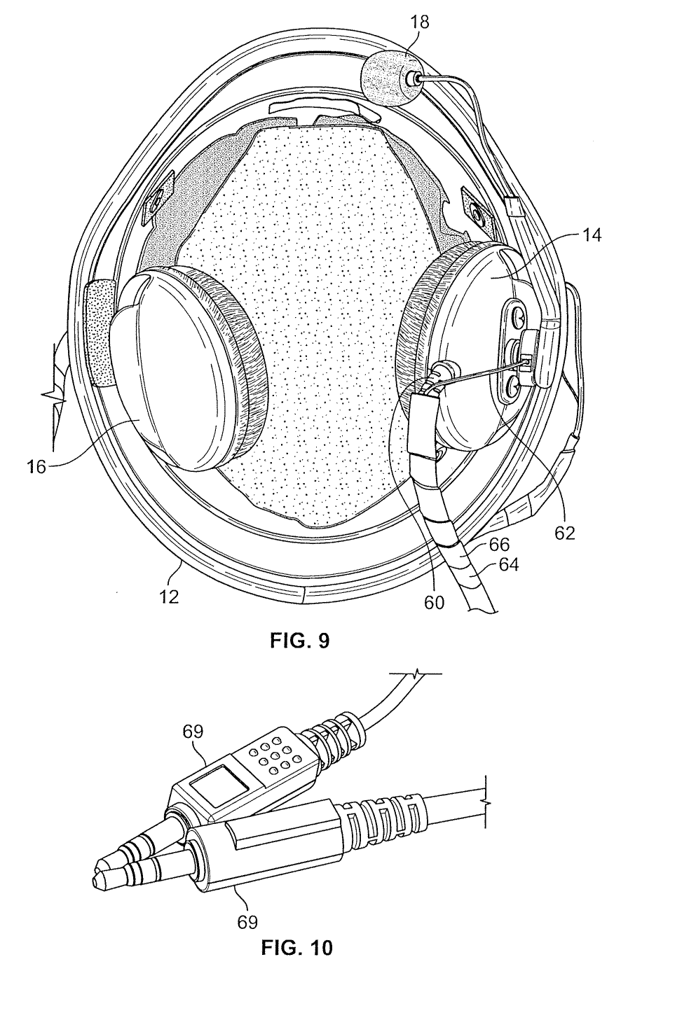

As can be seen in FIGS. 7 and 8, the cables 60, 62, may be separated for a section of the cable 64 to allow for manually manipulated switches. For instance, an on/off switch 90 may be provided for the microphone cable 62 for controlling the microphone 18, and a volume slider 92 may be provided for on the headphone cable 60 for controlling the volume in the headphones 14, 16.

Each of the headphones 14, 16, is secured with the helmet 12. In a first manner, releasable connections 70 may be used, as best seen in FIGS. 5 and 6. As shown, the releasable connections 70 include a hook strip 72 and a loop strip 74 for providing a hook-and-loop connection 76. This hook-and-loop connection 76 allows the headphones 14, 16, to be removed from the helmet 12 (such as for replacement) or to be repositioned with the helmet 12.

Another manner for connecting the headphones 14, 16, with the helmet 12 is by utilizing a bolt 80 or rivet or the like. As shown in FIGS. 4 and 6, the bolt 80 may extend from an exterior of the helmet 12 to an interior while also passing through a support bar 82 secured with one of the headphones 14, 16. In various forms, the headphones 14, 16, may be adjustable relative to the bar 82, the bar 82 may be adjustable relative to the bolt 80, or both. In one form, for example, a user may adjust the position of the headphone 14, 16, relative to the helmet 12, and then may retain the headphone 14, 16, in that position by pressing the hook strip 72 with the loop strip 74.

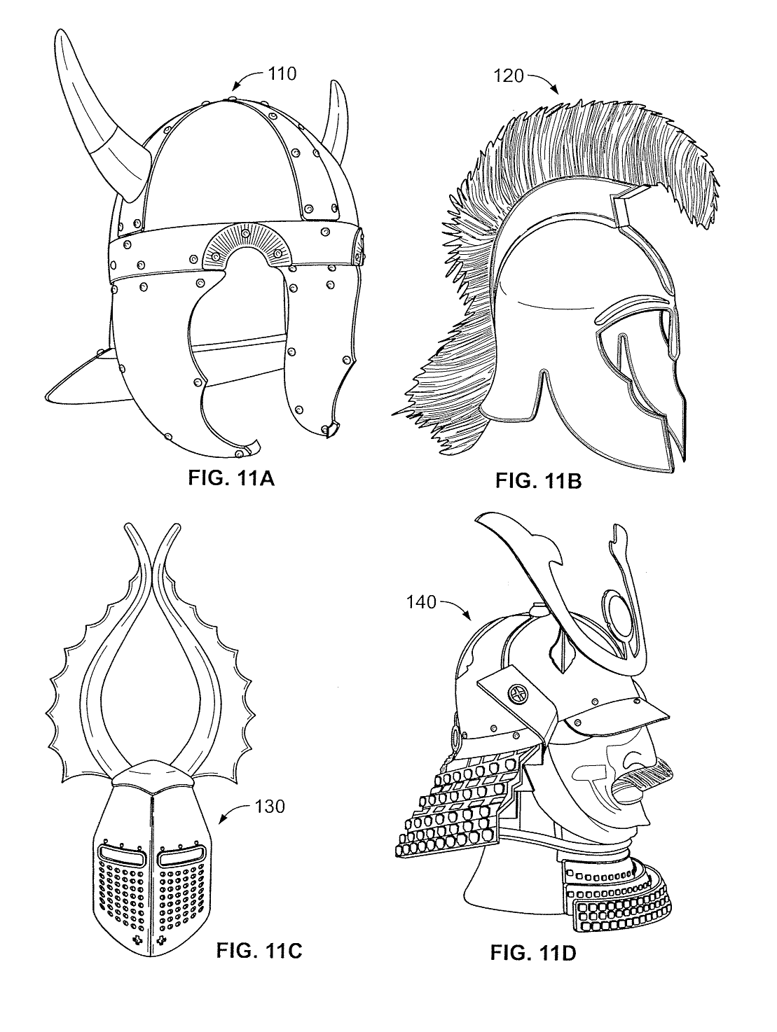

As discussed, the headgear 10 is provided with an aesthetic appearance suitable for various video games centered on what would variously be termed war, battle, combat, special forces or commando operations, etc., where at least one character has the appearance of a soldier. While there are many games of this genre, some common and popular games are titled and trademarked as Battlefield 1942, Battlefield 2, Battlefield 2142, Call of Duty and Call of Duty 2, Halo, Counter-Strike, and Medal of Honor (Series). Other genres may be fantasy, such as World of Warcraft which has 7 million registered players, or the Lord of the Rings series. As further examples, each of FIGS. 11A to 11D depict forms of headgear that may be equipped with the headphones 14, 16, and microphone 18 described above. FIG. 11A depicts a helmet 110 designed to be evocative of Viking or fantasy adventures, FIG. 11B depicts a helmet 120 evocative of pre-Christian (Ancient Greek) or Roman Empire adventures, FIG. 11C depicts a helmet 130 most appropriately termed fantasy, and FIG. 11D shows a samurai-styled helmet 140. Again, each of these helmets 110, 120, 130, 140, maybe equipped with the headphones 14, 16, and microphone 18.

In a feature of the invention, the headgear 10, with any desired form of genre-based aesthetic appearance, may be marketed to consumers and garners for displaying their connection or identity with a particular game. That is, a particular form of the headgear 10 may be provided with an aesthetic appearance to substantially mimic or correspond with headgear that is associated with characters of a specific video game. As an example, a particular World War II-themed video game may be selected. The helmet 12 and its World War II-aesthetic appearance may be selected or designed to correspond with a character from the World War II-themed video game. The helmet 12 may then be manufactured, marketed, and retailed as being associated with the World War II-themed video game. This preferably includes official licensing, if necessary, for a particular game with a particularly distinctive appearance for the characters.

In one form, the headgear 10 may be provided as a kit. That is, the headphones 14, 16, and microphone 18 may be manufactured and retailed so that a user would select a desirable helmet (such as helmets 12, 110, 120, 130, 140) associable with a particular game. Additionally, a consumer may purchase a single set of headphones 14, 16, and microphone 18, and a plurality of helmets that allow the consumer to selectively switch the helmet to be worn, depending on the game being played. Kits may also be provided that allow a user to personalize the helmet, such as by adding external features (such as horns, or hail, or other features common to helmets, as well as adding stickers (for instance) that give the appearance of bullet holes, represent “kills” or wins, or some other representation that is related to the play of the game itself).

As described, the headgear 10 enhances a game user's experience.

As used herein, the term helmet refers to a body portion such as any hat, headwear, headband, cap, or other support device designed to be placed on or about a user's head so as to be supported thereon or by another portion of the user's body (such as by shoulders), and so as to be able to support the microphone 18 and headphones 14, 16, to the extent described herein.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method of enhancing gaming experiences for a consumer, the method comprising:
selecting a video game genre;
providing a headgear apparatus;
providing the headgear apparatus with an aesthetic appearance corresponding to the video game genre; and
marketing the headgear apparatus as being associated with the video game genre.

2. The method of claim 1 wherein the step of selecting a video game genre includes selecting a particular video game.

3. The method of clam 2 wherein the step of marketing includes identifying to the consumer the particular video game.

4. In combination with a video game genre, a headgear apparatus comprising:
a helmet;
at least a first headphone secured with the helmet;
a microphone secured with the helmet,
wherein the helmet has an aesthetic appearance associable with the video game genre.

5. The combination of claim 4 wherein the video game genre is a specific selected video game having characters, and the aesthetic appearance corresponds to the aesthetic appearance of at least one of the characters of the selected video game.

6. A headgear apparatus for enhancing video gaming, the headgear apparatus comprising:
a body portion;
a microphone; and
first and second headphone speakers, wherein the body portion has an aesthetic appearance associable with video gaming.

7. The headgear apparatus of claim 6 wherein the body portion is a helmet for wearing on a user's head.

8. The headgear apparatus of claim 6 wherein the speakers are secured with the body portion, and the microphone is secured with the speakers.

9. The headgear apparatus of claim 6 wherein the microphone is secured to a boom for permitting adjustment of a position of the microphone.

10. The headgear apparatus of claim 6 further including a microphone cable, and a speaker cable, each cable provided with a jack for connecting the cables with a video gaming console.

11. The headgear apparatus of claim 6 further including a microphone cable, and a speaker cable, wherein the cables are substantially routed together.
